(19) United States
(12) Patent Application Publication
(10) Pub. No.: US 2016/0138763 A1
(43) Pub. Date: May 19, 2016

(54) LED LAMP

(71) Applicant: Yuan-Chou LIU, Hsinchu City (TW)

(72) Inventor: Yuan-Chou LIU, Hsinchu City (TW)

(21) Appl. No.: 14/918,709

(22) Filed: Oct. 21, 2015

(30) Foreign Application Priority Data
Nov. 13, 2014 (TW) 103139365

(51) Int. Cl. F21K 99/00; F21V 3/02; F21V 23/06; F21V 23/00

(52) U.S. Cl. CPC F21K 9/1355; F21K 9/90; F21V 23/002; F21V 23/005; F21V 3/02; F21V 23/06; F21Y 2101/02; F21Y 2105/001

(57) ABSTRACT

The present invention relates to an LED lamp comprising a bulb-shaped outer shell, a lamp plate assembly and a lamp socket. The bulb-shaped outer shell is formed of two half shells which can be bonded with each other in a left-right direction. Each of the two half shells has a groove on an inner surface thereof. The lamp plate assembly comprises a substrate, a plurality of first LEDs, a plurality of second LEDs and a conductive wire. The substrate comprises driving circuit elements and is inserted into an annular groove that is defined by the grooves of the two half shells. The substrate has a first surface and a second surface opposite to the first surface. The plurality of first LEDs and the plurality of second LEDs are respectively mounted on the first surface and the second surface of the substrate along a periphery of the substrate. An end of the conductive wire is electrically connected to the substrate. The lamp socket is connected to the bulb-shaped outer shell from a lower side of the bulb-shaped outer shell and is electrically connected to another end of the conductive wire.

### FIELD

The present invention relates to a light emitting diode (LED) lamp, especially to an LED lamp that can achieve an omnidirectional light emitting effect.

### BACKGROUND

In recent years, a use of LED in the lamp structure had become widespread. However, compared to the traditional incandescent lamp, the LED lamp belongs to a directional light source that has a problem of small light emitting angle, and a light emitting angle thereof needs to be enlarged by other design or improvement means. Additionally, heat dissipation ability is also a concerned important factor for LED.

In order to solve the problem of light emitting angle of LED, many different solutions had been proposed. For example, a solution of using a lens or a reflective/refraction layer on a shell to change light path emitted from LEDs, a solution of providing a plurality of LED lamp plates (e.g., a vertical lamp plate or the like) in different angles to make LEDs on the LED lamp plates emit light toward different directions, and a solution of providing fluorescence powders on a periphery of a translucent substrate and around LEDs had been proposed to achieve an omnidirectional light emitting effect, or the like. However, since LED lamps in these solutions need additional structures, they have problems of increasing cost, complicated assembling process, and the like. Moreover, since light emitted from LED is emitted outside through many times of reflections or refractions indirectly, such solutions also have a problem of undesired energy consumption.

### SUMMARY

In order to solve the above-mentioned problems, an object of the present invention is to provide an LED lamp that can achieve an omnidirectional light emitting effect by directly inserting a lamp plate assembly, which has a plurality of LEDs on two opposite surfaces thereof, into a groove on an inner surface of a bulb-shaped outer shell. And, such LED lamp also has advantages of a good heat dissipating ability, a reduced manufacturing and assembling cost, an improved light emitting efficiency and the like.

Specifically, an LED lamp according to an aspect of the present invention comprises a bulb-shaped outer shell, a lamp plate assembly and a lamp socket. The bulb-shaped outer shell is formed of two half shells which can be bonded with each other in a left-right direction, and each of the two half shells has a groove on an inner surface thereof. The lamp plate assembly comprises a substrate, a plurality of first LEDs, a plurality of second LEDs and a conductive wire. The substrate comprises driving circuit elements and is inserted into an annular groove that is defined by the grooves of the two half shells. The substrate has a first surface and a second surface opposite to the first surface. The plurality of first LEDs and the plurality of second LEDs are respectively mounted on the first surface and the second surface of the substrate along a periphery of the substrate. An end of the conductive wire is electrically connected to the substrate. The lamp socket is connected to the bulb-shaped outer shell from a lower side of the bulb-shaped outer shell and is electrically connected to another end of the conductive wire.

In addition, an LED lamp according to another aspect of the present invention comprises a bulb-shaped outer shell, a lamp plate assembly and a lamp socket. The bulb-shaped outer shell is formed of two half shells which can be bonded with each other in a left-right direction, and each of the two half shells has a groove on an inner surface thereof. The lamp plate assembly comprises two substrates, a plurality of first LEDs, a plurality of second LEDs and a conductive wire. The two substrates comprise driving circuit elements and are respectively inserted into the grooves of the two half shells. The two substrates together define a first surface and a second surface opposite to the first surface. The plurality of first LEDs and the plurality of second LEDs are respectively mounted on the first surface and the second surface along peripheries of the first surface and the second surface. An end of the conductive wire is electrically connected to the two substrates. The lamp socket is connected to the bulb-shaped outer shell from a lower side of the bulb-shaped outer shell and is electrically connected to another end of the conductive wire.

Preferably, a light emitting amount toward different directions of the LED lamp of the present invention can be adjusted by changing quantities of the first LEDs and the second LEDs. Thus, the LED lamp can be made to meet an actual demand in the lamp application and to avoid an unnecessary consumption of light.

Thus, when compared with the LED lamp of the prior art, the LED lamp of the present invention can achieve the omnidirectional light emitting effect and reduce the unnecessary energy consumption (that is, improve the light emitting efficiency) of LEDs by respectively providing the plurality of LEDs on the first and second surfaces of the substrate along its periphery without using any lens or coating layer. Moreover, since the substrate of the present invention has the LEDs and the driving circuit elements simultaneously and the substrate is directly inserted into the groove of the bulb-shaped groove without other assembling components, the LED lamp of the present invention can also effectively save manufacturing and assembling costs. The detail descriptions and advantages of the present invention refer to embodiments and drawings as shown below.

### BRIEF DESCRIPTION OF THE DRAWINGS

FIG. 1 is a perspective exploded schematic view of an LED lamp according to a first embodiment of the present invention;

FIG. 2 is a perspective schematic view of the LED lamp according to the first embodiment of the present invention;

FIGS. 3A and 3B are perspective schematic views of a lamp plate assembly of the LED lamp according to the first embodiment of the present invention;

FIGS. 4A to 4C are schematic views illustrating an assembling process of the LED lamp according to the first embodiment of the present invention;

FIG. 5 is a schematic view illustrating the light path of the LED lamp according to the first embodiment of the present invention;

FIG. 6 is a perspective exploded schematic view of an LED lamp according to a second embodiment of the present invention;

FIG. 7 is a perspective schematic view of the LED lamp according to the second embodiment of the present invention;

FIGS. 8A to 8C are schematic views illustrating an assembling process of the LED lamp according to the second embodiment of the present invention; and

FIG. 9 is a schematic view illustrating the light path of the LED lamp according to the second embodiment of the present invention.

### DETAILED DESCRIPTION

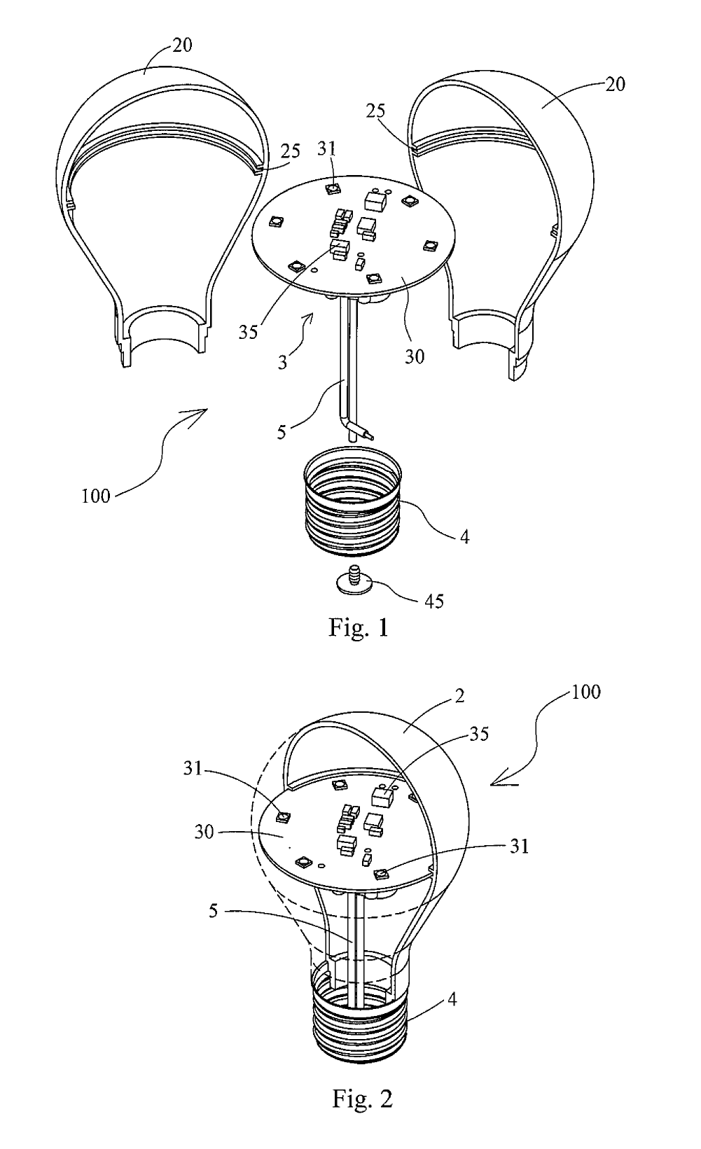

Referring to FIGS. 1 and 2, an LED lamp 100 of a first embodiment of the present invention comprises a bulb-shaped outer shell 2, a lamp plate assembly 3 and a lamp socket 4. The bulb-shaped outer shell 2 is formed of two half shells 20 which can be bonded with each other in a left-right direction, and has an appearance that is identical to an bulb-shaped outer shell of the traditional incandescent lamp. Each of the two half shells 20 has a groove 25 on an inner surface thereof. After the two half shells 20 are bonded with each other, the grooves 25 of the two half shells 20 form an annular groove 25 on the bulb-shaped outer shell 2. Preferably, such annular groove 25 is located at a position where a diameter of the bulb-shaped outer shell 2 is widest, but not limited to such position. The two half shells 20 are plastic half shells manufactured by the same mold and being structurally symmetrical with each other. When compared with the bulb-shaped outer shell made by glass, the bulb-shaped shell 2 of the present invention, which is formed of bonding two plastic half shells, further has advantages of lightweight, achieving better safety (anti-impact) and like.

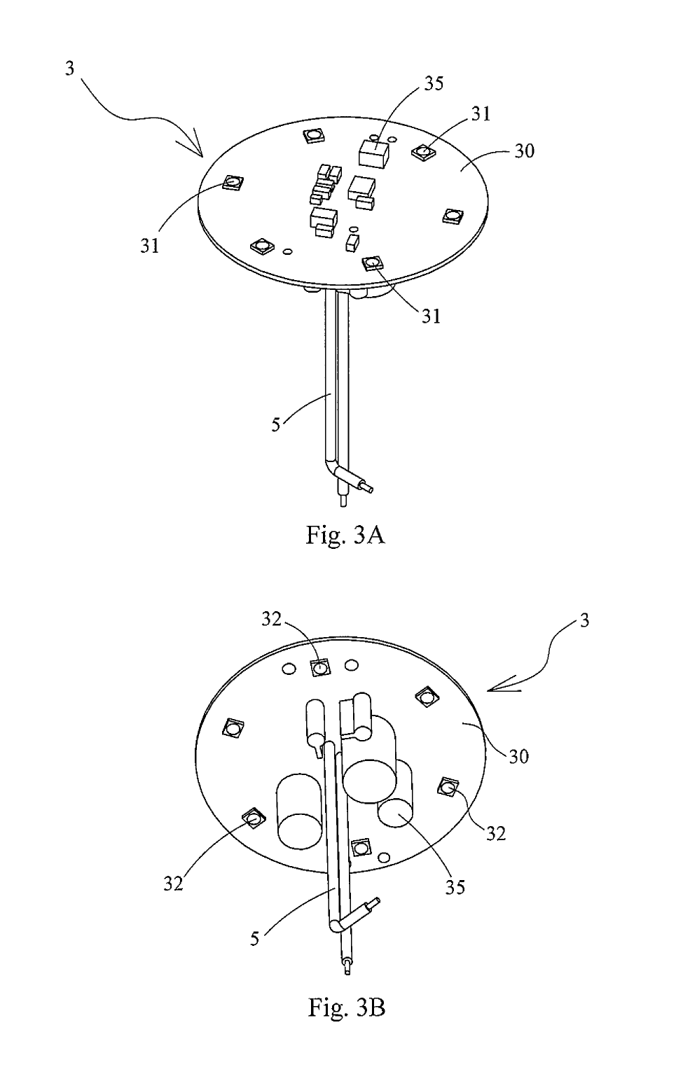

As shown in FIGS. 3A and 3B, the lamp plate assembly 3 comprises a substrate 30, a plurality of first LEDs 31, a plurality of second LEDs 32 and a conductive wire 5. The plurality of first LEDs 31 and the plurality of second LEDs 32 are respectively mounted on a first surface and a second surface of the substrate 30 along peripheries of the first surface and the second surface of the substrate 30. The substrate 30 further comprises driving circuit elements 35 for driving the first LEDs 31 and the second LEDs 32 to emit light. Referring back to FIGS. 1 and 2, the substrate 30 is inserted into the annular groove 25 of the bulb-shaped outer shell 2, which is formed by the grooves 25 in the two half shells 20. Two opposite ends of the conductive wire 5 are electrically connected to the substrate 30 and the lamp socket 4, respectively, by, for example, welding, screwing or the like.

Based on the above-mentioned structures, since the first LEDs 31 and the second LEDs 32 of the present invention are respectively mounted on the first and second surfaces of the substrate 30 along the periphery of the substrate 30, the first LEDs 31 and the second LEDs 32 can directly emit light to outside and achieve the omnidirectional light emitting effect without any assistance by lens or other structures. A schematic view of the light path of the LED lamp of the present invention is clearly shown in FIG. 5.

Moreover, although in drawings, a quantity of the first LEDs 31 and a quantity of the second LEDs 32 are the same, yet based on different requirements, the quantity of the first LEDs 31 and the quantity of the second LEDs 32 respectively on the first surface and the second surface of the substrate 30 can be changed. Thus, the amount of light emitted from the LED lamp toward different directions can be adjusted for meeting actual demands in the lamp application and avoiding an unnecessary consumption of light. On the other hand, if the quantities of the first LEDs 31 and the second LEDs 32 respective on the first surface and the second surface of the substrate 30 are not identical to each other, either the first surface of the substrate 30 or the second surface of the substrate 30 can be made to face downward (i.e. face to the lamp socket 4) depending upon the requirements. For example, when the quantities of the first LEDs 31 and the second LEDs 32 respective on the first surface and the second surface of the substrate 30 are not identical to each other such that the light emitting amount of the first surface of the substrate 30 is 80% and the light emitting amount of the second surface of the substrate 30 is 20%, either the first surface or the second surface of the substrate 30 can be provided toward downward for producing an LED lamp which emits a larger light amount (80%) toward its bottom side or toward its upper side. That is, in view of the above descriptions of the present invention, since a single substrate having different light emitting amounts on two sides thereof due to the different quantities of the first LEDs and the second LEDs mounted on the first and second surfaces of this single substrate is provided, a manufacturer can produce two different LED lamps that meet two different light emitting requirements by making the first or second surface of this single substrate face downward. Thus, the development cost of the lamp plate assembly can be reduced. Moreover, the light emitting amounts of the LED lamp toward different directions can also be controlled by the driving circuit elements. For example, the LED lamp can be controlled to emit light only toward an upper side or a lower side thereof by driving the LEDs on the first or second surface of the substrate to emit light. Alternatively, the LED lamp can also be controlled to emit light simultaneously toward the upper and lower sides thereof by driving the LEDs on both first and second surfaces of the substrate to emit light.

Contrarily, when compared to a case in which the quantities of the first LEDs 31 and the second LEDs 32 respective on the first surface and the second surface of the substrate 30 are not identical to each other, if the quantities of the first LEDs 31 and the second LEDs 32 respective on the first surface and the second surface of the substrate 30 are identical to each other, during manufacturing process, the manufacturer can make any one of the first and second surfaces of the substrate 30 face downward and assemble the substrate 30 to the bulb-shaped outer shell 2 without distinguishing the first and second surfaces of the substrate 30. Accordingly, the same LED lamp can be obtained with increasing convenience of assembling.

On the other hand, since the annular groove 25 is preferably located on the position where the diameter of the bulb-shaped outer shell 2 is widest, when compared to the lamp plate that is supported by the supporting base as disclosed in the prior art, the substrate 30 inserted in the annular groove 25 of the present invention has a large surface area. And, the heat generated by the first LEDs 31 and the second LEDs 32 on the substrate 30 can be transmitted to the bulb-shaped outer shell 2 by a direct contact between the substrate 30 and the annular groove 25 of the bulb-shaped outer shell 2. Thus, a better heat dissipating effect can be achieved by the bulb-shaped outer shell 2 that has a larger heat dissipating area exposed to air.

In view of above, the LED lamp of the present invention with the omnidirectional light emitting effect is formed only by necessary components such as the bulb-shaped outer shell, the lamp plate assembly and the lamp socket without any other optical components or dissipating components. The two half shells of the bulb-shaped outer shell are manufactured by using the same mold (i.e., only one set of mold is necessary). The lamp plate assembly is a combination of the lamp plate and the driving plate used in the traditional lamp structure. Consequently, since the LED lamp of the present invention has these features, in addition to the advantages of achieving the omnidirectional light emitting effect and the good heat dissipating effect, the LED lamp of the present invention can also significantly reduce the manufacturing cost such as materials, assembling and the like thereof

A method for manufacturing the LED lamp 100 according to the first embodiment of the present invention will be described below.

Firstly, providing the two half shells 20 and the lamp plate assembly 3 as shown in FIGS. 1, 3A and 3B. The structures of the two half shells 20 and the lamp plate assembly 3 had been disclosed in detail previously, and thus will be omitted here.

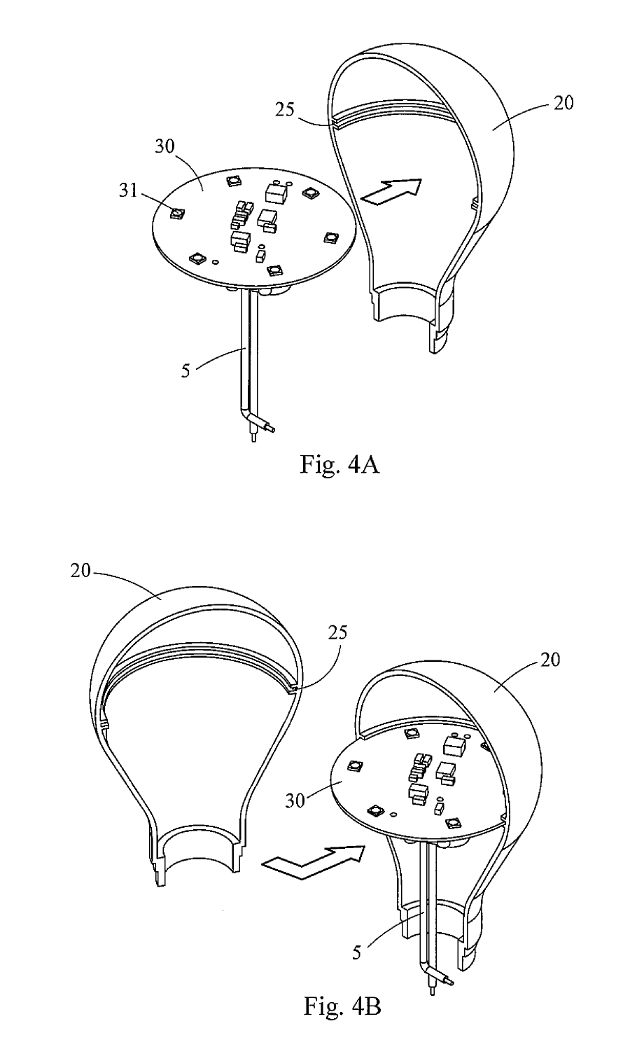

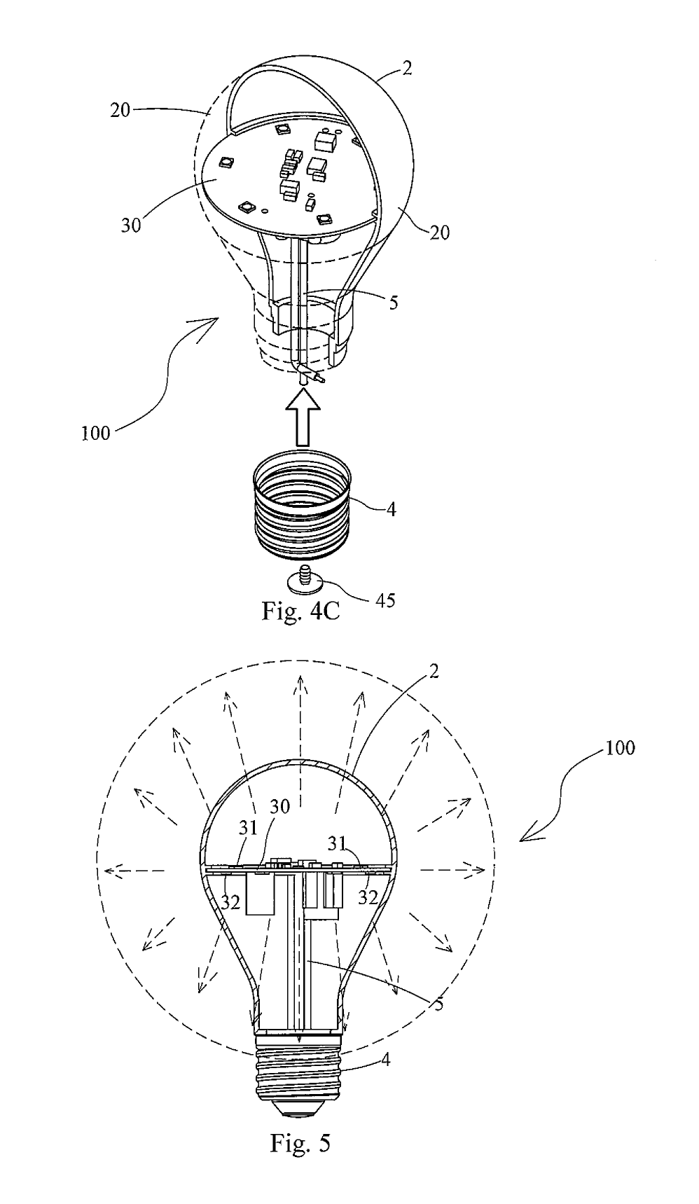

Next, as shown in FIGS. 4A to 4C, an assembling process of the LED lamp 100 of the first embodiment of the present invention will be described. A part of the substrate 30 is correspondingly inserted into the groove 25 of one of the half shell 20 at the right side along a direction indicated by an arrow in FIG. 4A to make the part (approximately to half part) of the substrate 30 being disposed in the right half shell 20, as shown in FIG. 4B. Then, aligning the groove 25 of the other half shell 20 on the left side to the remaining part of the substrate 30 that is still exposed outside and moving the other half shell 20 on the left side toward the right half shell 20. After the two half shells 20 are in contact with each other, bonding the two half shells 20 by using a method such as an ultrasonic bonding method, a press-fit bonding method or the like to form the bulb-shaped outer shell 2. At this time, another half part of the substrate 30 is disposed in the left half shell 20 with being inserted in the groove 25 of the left half shell 20, as shown in FIG. 4C. That is, after such bonding process, the substrate 30 is fixed in the annular groove 25 together defining by the two half shells 20. Finally, connecting the lamp socket 4 to the bulb-shaped outer shell 2 from the lower side of the bulb-shaped outer shell 2, and electrically connecting the other end of the conductive wire 5 with the lamp socket 4 by, for example, a rivet 45. Accordingly, the LED lamp 100 of the first embodiment of the present invention as shown in FIG. 2 is completed.

In view of the previous manufacturing method, it is obvious that the assembling method of the LED lamp 100 of the present invention merely needs to insert the lamp plate assembly into the annular groove 25 of the bulb-shaped outer shell 2 and does not need other additional elements (e.g., screws or the like) used in the traditional assembling method. Moreover, as mentioned in the above descriptions, except for the necessary bulb-shaped outer shell, lamp plate assembly and lamp socket, the LED lamp of the present invention in which the lamp plate assembly is a combination of the traditional lamp plate and driving plate does not need any other components. Thus, when compared with the traditional LED lamp, the LED lamp of the present invention does have an advantage of significantly reducing time and cost for manufacturing and assembling the LED lamp of the present invention.

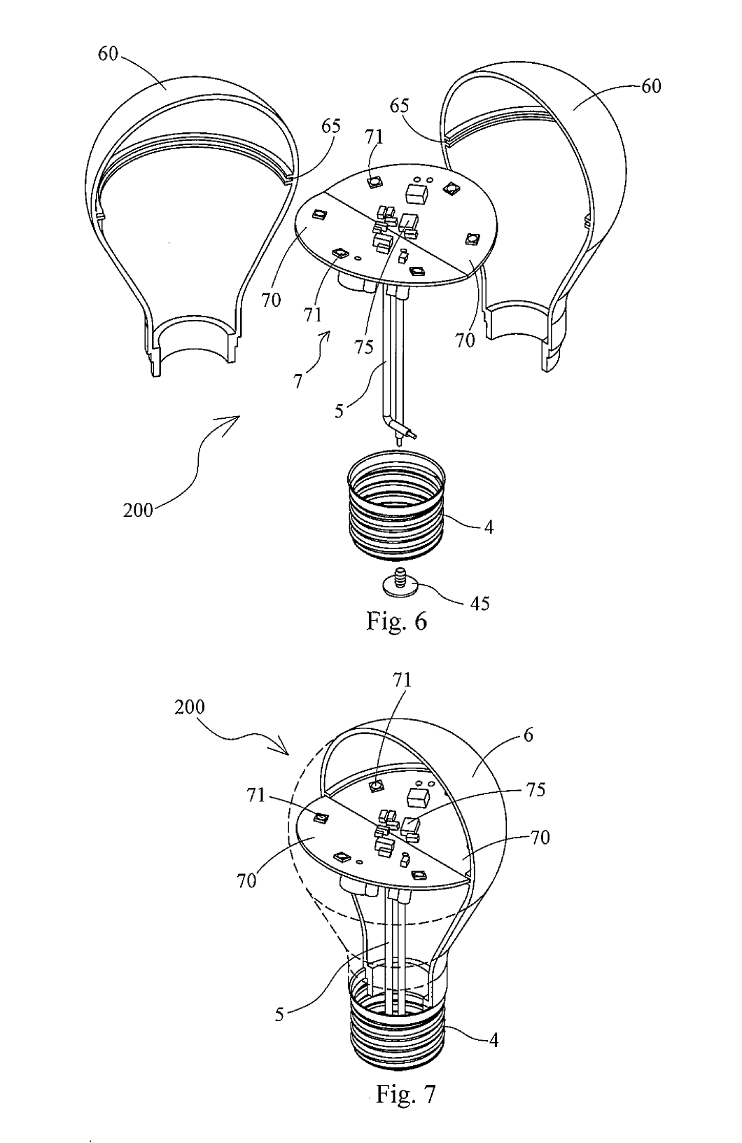

A LED lamp of a second embodiment of the present invention will be illustrated hereinafter. As shown in FIGS. 6 and 7, the LED lamp 200 according to the second embodiment of the present invention comprises a bulb-shaped outer shell 6, a lamp plate assembly 7 and a lamp socket 4. The bulb-shaped outer shell 6 is formed of two half shells 60 which can be bonded with each other in a left-right direction. Each of the two half shells 60 has a groove 65 on an inner surface thereof. Preferably, such groove 65 is substantially located at a position where a diameter of the bulb-shaped outer shell 6 is widest, and is inclined with respect to a center of the bulb-shaped outer shell 6 by an angle θ, as shown in FIG. 9. Note that the position where the groove 65 of each half shell 60 is located shall not be limited to the position as shown in FIG. 9. In addition, similar to the half shells 20 in the first embodiment of the present invention, the two half shells 60 of the second embodiment are plastic half shells manufactured by the same mold. Thus, the two half shells 60 of the second embodiment have the same advantages as the two half shells 20 of the first embodiment, which are thus to be omitted here.

The lamp plate assembly 7 comprises two substrates 70, a plurality of first LEDs 71, a plurality of second LEDs 72 and a conductive wire 5. The two substrates 70 together define a first surface and a second surface opposite to the first surface. The plurality of first LEDs 71 and the plurality of second LEDs 72 are respectively mounted on the first surface and the second surface of the two substrates 70 along peripheries of the first surface and the second surface (as shown in FIGS. 6 and 9). The two substrates 70 further comprise driving circuit elements 75 for driving the first LEDs 71 and the second LEDs 72 to emit light. The two substrates 70 are respectively inserted into the grooves 65 formed in the two half shells 60. Two opposite ends of the conductive wire 5 are respectively electrically connected to the substrates 70 and the lamp socket 4.

Moreover, in the second embodiment of the present invention, similar to the first embodiment of the present invention, the light emitting amounts of the LED lamp toward different directions can be adjusted by the way of changing quantities of the first LEDs 71 and the second LEDs 72 on the first and second surfaces of the two substrates 70, and the like. Additionally, in the second embodiment of the present invention, similar to the first embodiment of the present invention, if the quantities of the first LEDs 71 and the second LEDs 72 on the first and second surfaces of the two substrates 70 are not identical to each other, at least two LED lamps that meet at least two different light emitting requirements can be manufactured from the two substrates 70 on which the first LEDs 71 and the second LEDs 72, which are not identical to each other in quantity, are mounted by the manufacturer. Thus, the development cost of the lamp plate assembly can be reduced. The reasons and examples thereof, which can be understood by referring to the descriptions as to the first embodiment of the present invention, are omitted here.

A method for manufacturing the LED lamp 200 according to the second embodiment of the present invention will be described below.

Firstly, providing the two half shells 60 and the lamp plate assembly 7 as shown in FIGS. 6 and 7. The structures of the two half shells 60 and the lamp plate assembly 7 had been disclosed in detail previously, which are thus omitted for concision.

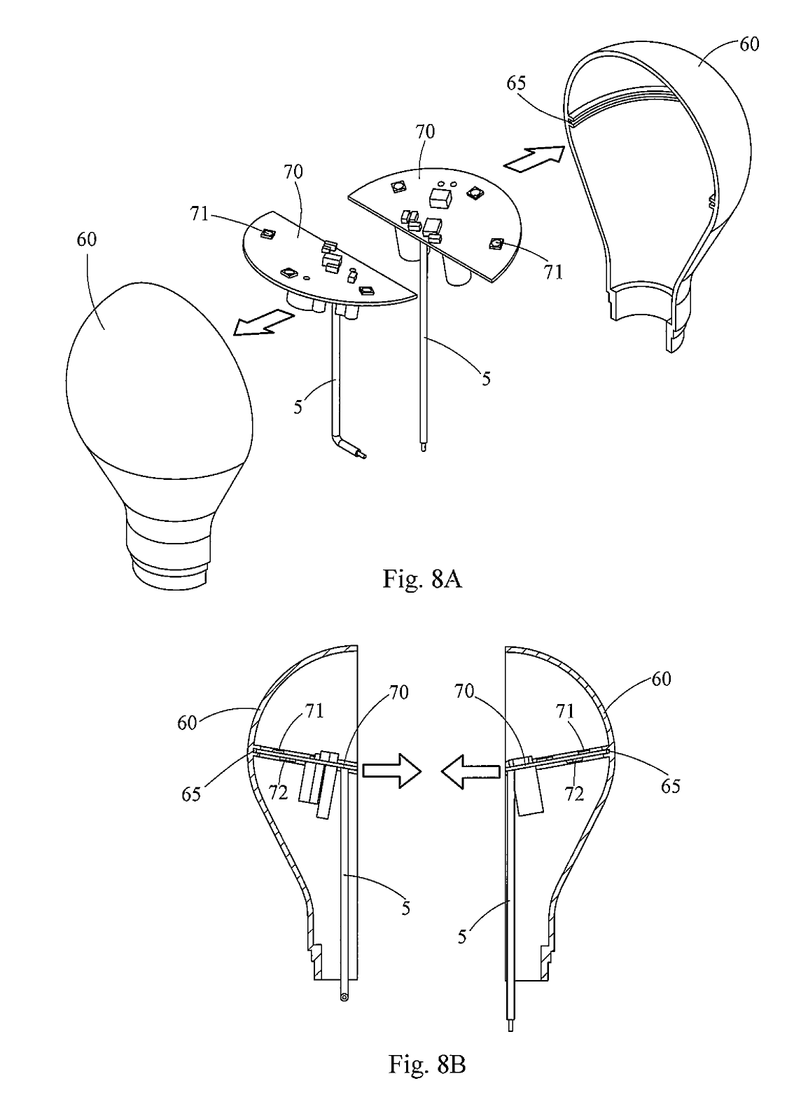

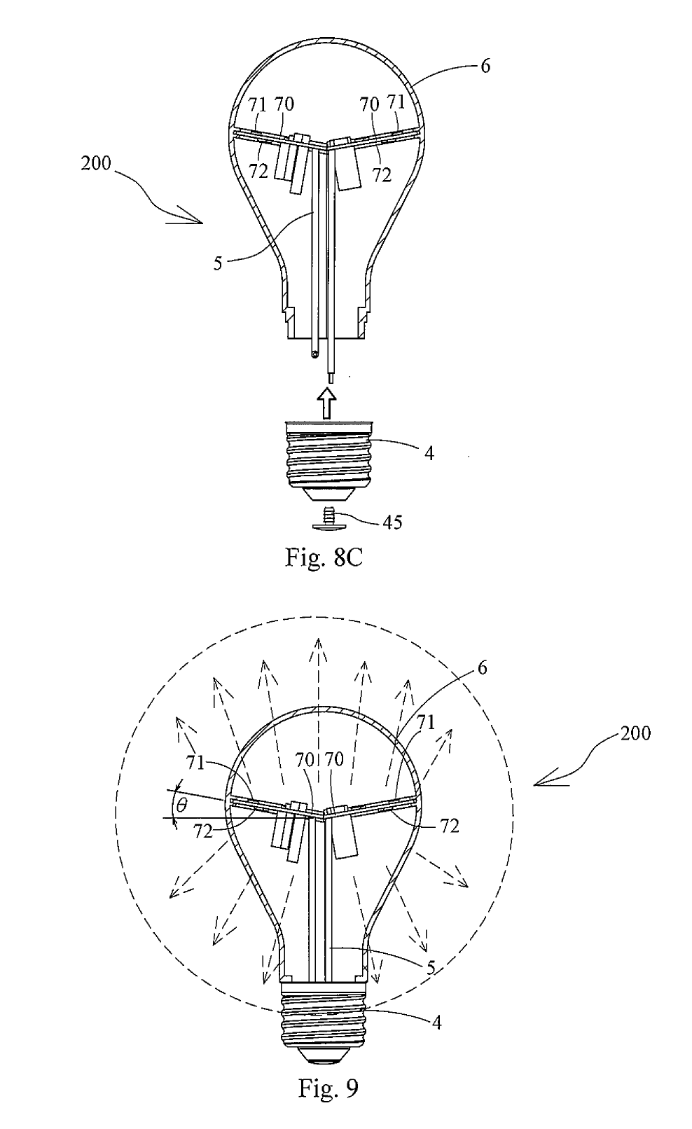

Next, as shown in FIGS. 8A to 8C, an assembling process of the LED lamp 200 of the second embodiment of the present invention will be described. In the beginning, as indicated by arrows in FIG. 8A, the two substrates 70 are inserted into the grooves 65 of the two half shell 60 by the angle θ of which the grooves 65 of the two half shells 60 are inclined. As a result, the two substrates 70 are located in the two half shells 60 correspondingly. Then, as shown in FIG. 8B, bonding the two half shells 60 by using a method such as an ultrasonic bonding method, a press-fit bonding method or the like to form the bulb-shaped outer shell 6, as shown in FIG. 8C. Finally, connecting the lamp socket 4 to the bulb-shaped outer shell 6 from the lower side of the bulb-shaped outer shell 6, and electrically connecting the other end of the conductive wire 5 with the lamp socket 4 by, for example, a rivet 45. Accordingly, the LED lamp 200 of the first embodiment of the present invention as shown in FIG. 7 is completed.

In view of the above-mentioned descriptions, since the two substrates 70 are inserted into the grooves 65, which are inclined with respect to the center of the bulb-shaped outer shell 6 by the angle θ, of the two half shells 60, the light emitting angles of the first LEDs 71 and the second LEDs 72 on the first and second surfaces of the two substrates 70 are also inclined from a horizontal plane by the angle θ. Thus, by changing the inclined angle θ of the groove 65, the LED lamp 200 of the second embodiment of the present invention can achieve more efficient light emitting angles based on different requirements. Moreover, in addition to the advantage of the adjustable light emitting angle from changing the inclined angle θ of the groove 65, the LED lamp of the second embodiment of the present invention also has advantages that are identical to that of the LED lamp of the first embodiment of the present invention as previously presented.

What is claimed is:

1. A light emitting diode (LED) lamp comprising:
a bulb-shaped outer shell formed of two half shells which are configured to be bonded with each other in a left-right direction, each of the two half shells having a groove on an inner surface thereof;
a lamp plate assembly comprising a substrate, a plurality of first LEDs, a plurality of second LEDs and a conductive wire, wherein the substrate comprises driving circuit elements and is inserted into an annular groove that is defined by the grooves of the two half shells, the substrate has a first surface and a second surface opposite to the first surface, the plurality of first LEDs and the plurality of second LEDs are respectively mounted on the first surface and the second surface of the substrate along a periphery of the substrate, and an end of the conductive wire is electrically connected to the substrate; and
a lamp socket connected to the bulb-shaped outer shell from a lower side of the bulb-shaped outer shell and being electrically connected to another end of the conductive wire.

2. The LED lamp of claim 1, wherein the annular groove is disposed at a location where a diameter of the bulb-shaped outer shell is widest.

3. The LED lamp of claim 1, wherein a quantity of the plurality of first LEDs is different with a quantity of the plurality of second LEDs.

4. The LED lamp of claim 3, wherein any one of the first surface and the second surface of the substrate is configured to face the lamp socket.

5. The LED lamp of claim 2, wherein a quantity of the plurality of first LEDs is different with a quantity of the plurality of second LEDs.

6. The LED lamp of claim 5, wherein any one of the first surface and the second surface of the substrate is configured to face the lamp socket.

7. A light emitting diode (LED) lamp comprising:
a bulb-shaped outer shell formed of two half shells which are configured to be bonded with each other in a left-right direction, each of the two half shells having a groove on an inner surface thereof;
a lamp plate assembly comprising two substrates, a plurality of first LEDs, a plurality of second LEDs and a conductive wire, wherein the two substrates comprise driving circuit elements and are respectively inserted into the grooves of the two half shells, the two substrates together define a first surface and a second surface opposite to the first surface, the plurality of first LEDs and the plurality of second LEDs are respectively mounted on the first surface and the second surface of the substrate along peripheries of the first surface and the second surface, and an end of the conductive wire is electrically connected to the two substrates; and
a lamp socket connected to the bulb-shaped outer shell from a lower side of the bulb-shaped outer shell and being electrically connected to another end of the conductive wire.

8. The LED lamp of claim 7, wherein the groove of each of the two half shells is substantially disposed at a location where a diameter of the bulb-shaped outer shell is widest, and the groove of each of the two half shells is inclined with respect to a center of the bulb-shaped outer shell from a horizontal plane.

9. The LED lamp of claim 7, wherein a quantity of the plurality of first LEDs is different with a quantity of the plurality of second LEDs.

10. The LED lamp of claim 9, wherein any one of the first surface and the second surface is configured to face the lamp socket.

11. The LED lamp of claim 8, wherein a quantity of the plurality of first LEDs is different with a quantity of the plurality of second LEDs.

12. The LED lamp of claim 11, wherein any one of the first surface and the second surface is configured to face the lamp socket.

13. A method for manufacturing an LED lamp, the method comprising:
providing two half shells each having a groove on an inner surface thereof;
providing a lamp plate assembly, the lamp plate assembly comprising a substrate, a plurality of first LEDs, a plurality of second LEDs and a conductive wire, wherein the substrate comprises driving circuit elements and has a first surface and a second surface opposite to the first surface, the plurality of first LEDs and the plurality of second LEDs are respectively mounted on the first surface and the second surface of the substrate along a periphery of the substrate, and an end of the conductive wire is electrically connected to the substrate;
inserting a part of the substrate into the groove of one of the two half shells;
aligning the groove of another one of the two half shells with the substrate and moving the another one of the two half shells toward the substrate in a manner that another part of the substrate is inserted in the groove thereof, and bonding the two half shells to form a bulb-shaped outer shell; and
connecting a lamp socket to the bulb-shaped outer shell from a lower side of the bulb-shaped outer shell and electrically connecting another end of the conductive wire and the lamp socket.

14. The method of claim 13, wherein the groove of each of the two shells is disposed at a location where a diameter of the bulb-shaped outer shell is widest.

15. The method of claim 13, wherein a quantity of the plurality of first LEDs is different with a quantity of the plurality of second LEDs.

16. The method of claim 15, wherein when inserting the part of the substrate into the groove of the one of the two half shells, any one of the first surface and the second surface of the substrate is configured to face downward.

17. The method of claim 14, wherein a quantity of the plurality of first LEDs is different with a quantity of the plurality of second LEDs.

18. The method of claim 17, wherein when inserting the part of the substrate into the groove of the one of the two half shells, any one of the first surface and the second surface of the substrate is configured to face downward.

19. A method for manufacturing an LED lamp, the method comprising:
providing two half shells each having a groove on an inner surface thereof;
providing a lamp plate assembly, the lamp plate assembly comprising two substrates, a plurality of first LEDs, a plurality of second LEDs and a conductive wire, wherein the two substrates comprise driving circuit elements and together define a first surface and a second surface opposite to the first surface, the plurality of first LEDs and the plurality of second LEDs are respectively mounted on the first surface and the second surface of the substrate along peripheries of the first surface and the second surface, and an end of the conductive wire is electrically connected to the two substrates;
respectively inserting the two substrates into the grooves of the two half shells;
bonding the two half shells to form a bulb-shaped outer shell; and
connecting a lamp socket to the bulb-shaped outer shell from a lower side of the bulb-shaped outer shell and electrically connecting another end of the conductive wire and the lamp socket.

20. The method of claim 19, wherein the groove of each of the two shells is substantially disposed at a location where a diameter of the bulb-shaped outer shell is widest, and the groove of each of the two shells is inclined with respect to a center of the bulb-shaped outer shell from a horizontal plane.

21. The method of claim 19, wherein a quantity of the plurality of first LEDs is different with a quantity of the plurality of second LEDs.

22. The method of claim 21, wherein when respectively inserting the two substrates into the grooves of the two half shells, any one of the first surface and the second surface is configured to face downward.

23. The method of claim 20, wherein a quantity of the plurality of first LEDs is different with a quantity of the plurality of second LEDs.

24. The method of claim 23, wherein when respectively inserting the two substrates into the grooves of the two half shells, any one of the first surface and the second surface is configured to face downward.
